(19) United States
(12) Patent Application Publication
(10) Pub. No.: US 2003/0179178 A1
(43) Pub. Date: Sep. 25, 2003

(54) Mobile Text Entry Device

(75) Inventor: Brian O Zargham, Makanda, IL (US)

Correspondence Address: BRIAN O. ZARGHAM, P.O. BOX 70, (1 S. TWIN RIDGE DRIVE), MAKANDA, IL, 62958, US

(73) Assignee: Brian O Zargham, Makanda, IL (US)

(21) Appl. No.: 10/249,597

(22) Filed: Apr. 23, 2003

(51) Int. Cl. G09G 5/00

(52) U.S. Cl. 345/156; 345/168

(57) ABSTRACT

The present invention is a hand-held text entry device that is small, simple, inexpensive, and suitable for any type of environment or position (day, night, sitting, standing, walking, public facilities, transportation systems, etc.). Furthermore, the device is adaptable and suitable for use by either hand to incorporate its usage among individuals with disabilities. It fits in a user's palm and has a set of sensors that are activated either by the user's fingertips or by the movement of the user's wrist. The present invention is based on the QWERTY keyboard that can be divided into two halves; it can thus be designed in two different ways. Either the user can hold two devices, one in each hand, so that each part acts as one half of the traditional QWERTY keyboard or the user can hold only one device in one hand to serve as a full size keyboard. In the latter case, tilting the device will swap between the two halves of QWERTY.

### BACKGROUND OF INVENTION

In general, text/data entry devices can be classified into three major groups; 1) Hand Mounted Devices, 2) Visual Interpretation Devices, and 3) Hand-Held Devices. In the following sub-sections each of them is briefly explained by use of some proposed ideas or commercially available products.

Hand Mounted Devices.Several devices have been created to use sensors, mounted on fingers or hands to address the problem of text entry without requiring a standard keyboard. In general, these devices are in the form of a glove or object, which contains some sensors or switches. The sensors or switches generate the signals that would normally be generated by pressing a key on a typical keyboard. U.S. Pat. No. 6,097,374 entitled “Wrist-Pendent Wireless Optical Keyboard,” discloses an optical reflectance matrix with a radio transmitter secured to each wrist of the user, and a base station connected to the computer. The optical reflectance matrix includes an array of LED's illuminating columns in a plane below the palm of the user's hand, from which the reflections of the user's fingers are detected by means of an array of phototransistors.

The user selects a particular keyboard's key by extending one of his/her fingers downward, entering the optical plane below the palm illuminated by the LED's. The resulting reflection activates one of the phototransistors in the detector array. Each hand is able to select half of the keys on a standard “QWERTY” keyboard.

U.S. Pat. No. 6,304,840 entitled “Fingerless Glove for Interacting with Data Processing System,” proposes an apparatus, which includes a glove that leaves the user's fingertips uncovered. The keyboard's key selection is based on the detection of the angles of a bending finger. The angle at which the user's finger bends at the proximal in the terphalangeal joint relates to the decoding of a particular keyboard's row. The user is required to tap the surface of an object, such as a table, with his/her finger to form the proper angle.

When a user types on a standard QWERTY keyboard with all ten fingers, the index and little fingers each control two or more columns of keys, where as the other fingers control only one column. To distinguish between the columns that are covered by a particular finger, such as the index finger, sensors (magnetic reed switches) are mounted on the index finger and the neighboring finger to close or open the switch depending on whether the index finger is being abducted or adducted.

There have been other inventions similar to the above glove; in fact, U.S. Pat. No. 5,581,484 discloses a glove which includes a pressure sensor and a pair of acceleration sensors on each fingertip. The pressure sensor measures the applied force when the finger depresses a surface as the acceleration sensor measures the acceleration of the user's finger. The current position of the finger relative to the beginning position is obtained by computing twice the integration of the measured acceleration.

U.S. Pat. No. 20,010,040,550 entitled “Multiple Pressure Sensors per Finger of Glove for Virtual Full Typing,” discloses a glove that has an array of pressure sensors mounted longitudinally at the fingertips. This invention is based on the fact that when a user strikes a particular keyboard key the acting finger, in result, forms a specific angle. The varying position of a fingertip on a surface distinguishes itself from other keys in different rows. The array of pressure sensors placed on one's various fingertips are activated depending on the finger's orientation when contacting a surface. Similar to U.S. Pat. No. 6,304,840, where magnetic reed switches are mounted between the index finger (or small finger) and a neighboring finger to distinguish between different key columns.

Although all of the above devices solve the problem of carrying a large keyboard, they introduce other problems. The inaccuracy and inconvenience of wearing a glove whenever needing to type a statement will usually prevent one from using such a device. Another consequence is that one's movements will be restricted as a foreign motion could send an undesired signal. For example, scratching one's head or holding a cup of coffee may produce undesirable inputs. So although these designs have some advantages, there are some disadvantages that hold them from becoming practical.

Visual Interpretation Devices: U.S. Pat. No. 20,020,061,217 entitled “Electronic Input Device,” discloses a device that detects the position of a user's finger. The position of which is detected by sending out a light beam (or other electromagnetic source or sound wave) parallel to the surface of a table, and then examining the reflection of the light beam as it is blocked by the finger. By determining the position of the finger, the device then correlates this position with a predefined keyboard map to identify the intended key press from the user. The user sits in front of the light beam source and types as if there is a physical keyboard. When the user imitates the depression of a key, his/her finger interrupts the plane of light, and a reflection is detected.

Other devices in this group include touch screen systems and optical touch panels. In these systems an optical source generates a series of light beams that cross the surface of a computer screen (part of the screen is used to display the keyboard or required input keys). When no object, such as a user's finger, blocks the light beam, the light travels to a detector, producing a continuous photocurrent. If the user's finger blocks a beam, the position of a discontinuous photodetector current will indicate which key has been pressed.

Although these systems do not require for the user to wear a glove, they are usually unreliable and require a video display terminal which are inconvenient for small hand-held devices. They also limit the type of environments in which they can be used; leading one to examine the use of hand-held keyboards.

Hand-Held Devices: Among the available (proposed) hand-held devices, there are keyboards with three keys, five keys, eight to twenty keys, or twenty-six plus keys. In the device with 3 keys, a cursor moves over a string of alphabet characters by the user depressing a left-arrow key or a right-arrow key. Once the cursor is placed on the desired character, the character is selected by using a select key. Mackenzie, I. S. and R. W. Soukoreff (in the paper entitled “Text Entry for Mobile Computing: Models and Methods, Theory and Practice,” Human-Computer Interaction, 17, 2002, 147-198) has proposed different techniques for the recording of characters while minimizing the distance the cursor must move to reach the next character. In order to reach a character the user must depress a key for a certain number of times. This is commonly referred to as the number of keystrokes required which for Mackenzie's numerous techniques varies from 10.66 to 4.23. Entry rates were about nine to ten words per minute based on an experiment with ten participants. In the device with five keys, four keys move a cursor on a two-dimensional set of characters on a screen while a fifth key selects a character. The phone keypads often have eight to twenty keys where eight keys are used to encode A-Z characters.

Keyboards such as in U.S. Pat. No. 6,102,594 entitled “Keyboard for touch typing using only one hand” employ a reduced number of full size keys. A single key on the half keyboard represents two characters, toggled by a space bar function. When the space bar is depressed while typing, the second character is used and thus the keyboard size is minimized yet still efficient. There are many devices with more than twenty-six keys that include miniature complete keyboards. Folding keyboards are another option; however, these are inconvenient for mobile technology due to the requirement of a full size support surface. The one handed keyboard, likewise, requires a support surface yet is smaller in area. So although both have not evolved into the ideal traveling keyboards, yet minimizing size is evident.

### SUMMARY OF INVENTION

The objective of this invention is to provide a novel hand-held text entry apparatus that is pocket size, simple, and can be used in any type of environment or position (day, night, sitting, standing, walking, public facilities, transportation systems, etc.). This apparatus can also be manufactured in such a way that there are either one or two units. When it is designed as a single unit device, the user is able to hold it in one hand and enter text by the use of his/her fingers; also allowing individuals with disabilities to use the device. The performance of the user's text entry speed can be improved by designing the apparatus so that it has two units. In this case, the user holds one unit in each hand and uses all ten fingers to enter text. Each unit fits in a user's palm and has a set of sensors that are activated either by the user's fingers or by the movement of the user's wrist. Furthermore, each unit includes a sensing subsystem; the subsystem is operative to recognize the stimuli sensed at different activated sensors. The transformation of signals from a sensing subsystem to a receiving subsystem (or an information processing system) is done via wireless or optical technology, e.g., via radio frequency (RF) or infrared (IR).

### BRIEF DESCRIPTION OF DRAWINGS

FIG. 1 is an illustration of a user's hand holding a hand-held text entry device and subsystems for receiving, processing, and displaying the entered text;

FIG. 2 is a perspective view of the hand-held text entry device presented in FIG. 1;

FIG. 3 is a representation of a template consisting of five columns which map the sensors of the hand-held entry device shown in FIG. 2 to the standard keyboard's keys; and

FIG. 4 is a representation of a template consisting of six columns which map the sensors of the hand-held entry device shown in FIG. 2 to the standard keyboard's keys

### DETAILED DESCRIPTION

The proposed hand-held text entry is based on the QWERTY keyboard which can be divided into two halves; mimicking ideas given in (Buxton, W., et al., “One-handed Touch Typing on a QWERTY Keyboard,” Human-Computer Interaction, 11, 1996, 1-27). The present invention can thus be designed in two different ways. Either the user can hold two devices, one in each hand, so that each part acts as one half of the traditional QWERTY board or the user can hold one device in one hand to serve as a full size keyboard. The advantage to the latter design is that it allows the user to type any character using just one hand. Given the fact that the speed of typing with either hand is the same, the dominant hand is able to perform other functions such as holding a sandwich or a drink. In the following, the design of a one handed of the present invention is explained.

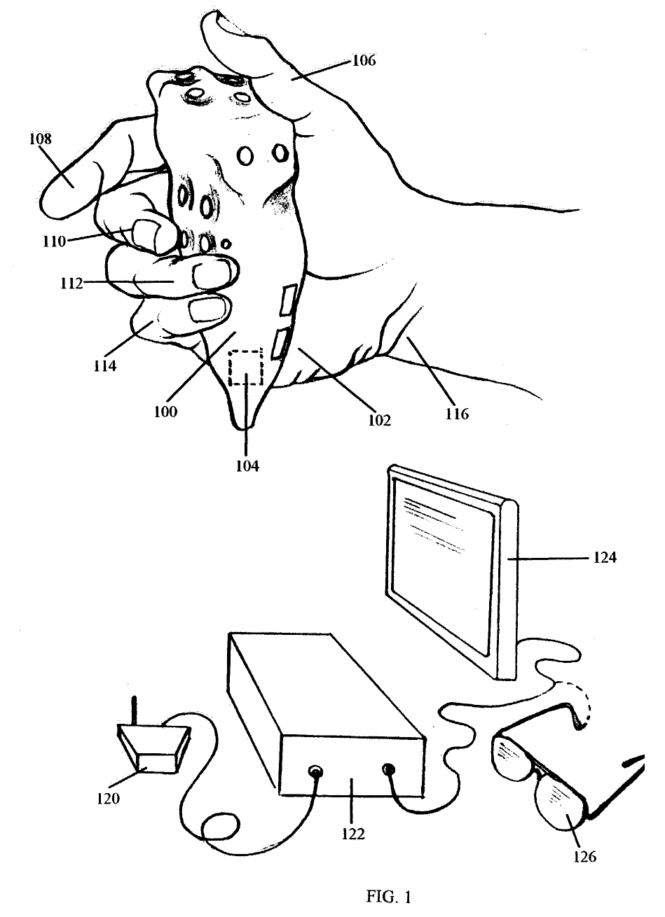

Referring now to the drawings, FIG. 1 represents the present invention and its correspondent subsystems in operation. The handheld device has a body shape 100 that can easily be held in the palm 102 of a user's hand. In addition to a set of sensors, the body 100 includes a sensing subsystem 104 that transmits a specific signal corresponding to a sensor (or set of sensors) that is (are) pressed by the user's finger(s) 106-114 or moved by the user's wrist 116. The signals generated by the sensing subsystem 104 are received by the receiving subsystem 120, which delivers them to an information processing system 122. The transformation of signals from 104 to 122 can be done via wireless technology or optical technology, e.g., RF or IR. The character corresponding to the signals obtained by the information processing 122, can be displayed in a variety of ways, e.g. via display panel 124 or a pair of glasses 126.

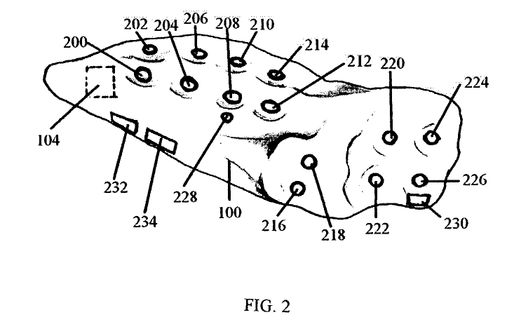

FIG. 2 represents the position of the sensors 200-234 on the body of the present invention. Considering both FIG. 1 and FIG. 2, when the user holds the hand-held device by the right hand in home position, the index finger 108 is placed on sensors 212 and 214. The middle finger 110 is placed on sensors 208 and 210 and is also able to reach to the sensor 228 in order to control this sensor. The ring finger 112 is placed on sensors 204 and 206. The little finger 114 is placed on sensors 200 and 202. Finally, the thumb 106 is placed on the sensors 220 and 222, and is able to move right or left in order to control the sensors 224, 226, 216, and 218. The sensor 232 detects whether the hand-held device is tilted to right or left, where sensor 234 detects tilting to the front or back position. The sensor 230 detects whether the thumb is placed on the sensors 220 and 222, or 224 and 226. Each of sensors 200-228 comprises, for example, a pressure sensor or a simple miniature switch. One example could be to use seven Momentary/Off/Momentary rocker switches (part # SW311-ND at DigiKey Corporation) as sensors 200-226, and to use a push-button switch (part # 140300021 Gateway Electronics) for sensor 228. The sensors 232 and 234 can be tilt switches (part # 140000038Gateway Electronics), an accelometer, or a gyrometer. The sensor 230 can be a light detector.

To map the sensors to the standard keyboard's keys, several different templates can be used. Here, in order to represent the ability of the present invention adaptability, two of them are represented and discussed.

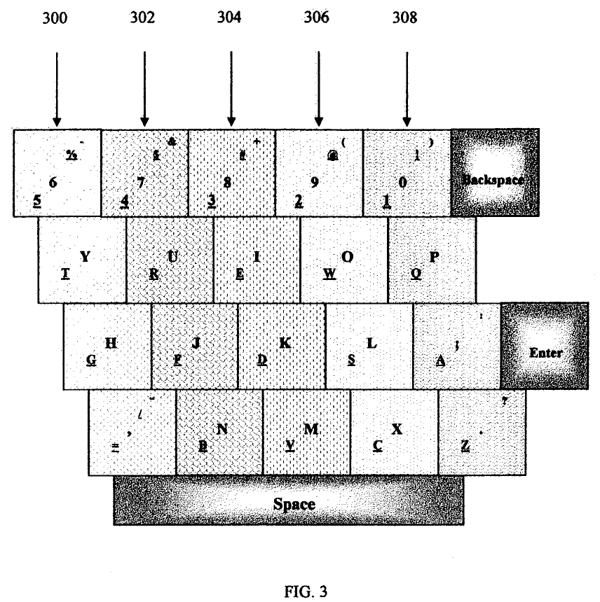

As was previously mentioned, the one handed hand-held device functions as a full-sized keyboard and allows the user to type any character. FIG. 3 shows how the keys in the left half of the QWERTY keyboard are mapped in a mirror image to the right half of the QWERTY keyboard. In this figure, the characters in bold (such as “9” and “(”) become available when the hand-held device is tilted (through sensor 232) in the right hand mode. The characters that are underlined ( such as “2” and “@”) become available in the left hand mode.

The secondary function of each key (denoted at the northeast corner of each cell, such as “@” and “(”) can be achieved by tilting the device in the direction of the tilt sensor 234. If one desires the character “y” to be capitalized then when the device is set in the right hand mode the user must tilt the device in the direction of sensor 234 and press (or touch) the sensor assigned to the character “y”, then a “Y” is rendered. Considering FIG. 1, FIG. 2, and FIG. 3, when the device is held by the right hand in home position, the index finger is placed on sensors 212 and 214. The letter “u” is typed by pressing 212, and the letter “j” is typed by pressing 214. The letters “y” and “h” are typed by, respectively, the sensors 220 and 222 that are controlled by the thumb or prosthetic opposing digit. Therefore, the cells in the leftmost column 300 are selected by the thumb or prosthetic opposing digit. The cells in the second leftmost column 302 are selected by the index finger or prosthetic pointing digit. The cells in the third column 304 from the left are selected by the middle finger or corresponding prosthetic digit, and the cells in the forth column 306 from the left are for use by the ring finger or corresponding prosthetic digit. The cells in the rightmost column 308 are then controlled by the little finger or corresponding prosthetic digit. The user can swap between the two middle rows of the keyboard to that of the first and fourth by moving the thumb or prosthetic opposing digit from sensors 220-222 to sensors 224-226. Sensors 216 and 218 are used as a backspace and enter keys, respectively. Sensor 228 is controlled by the middle finger or corresponding prosthetic digit. Sensor 228-functions as the space bar key.

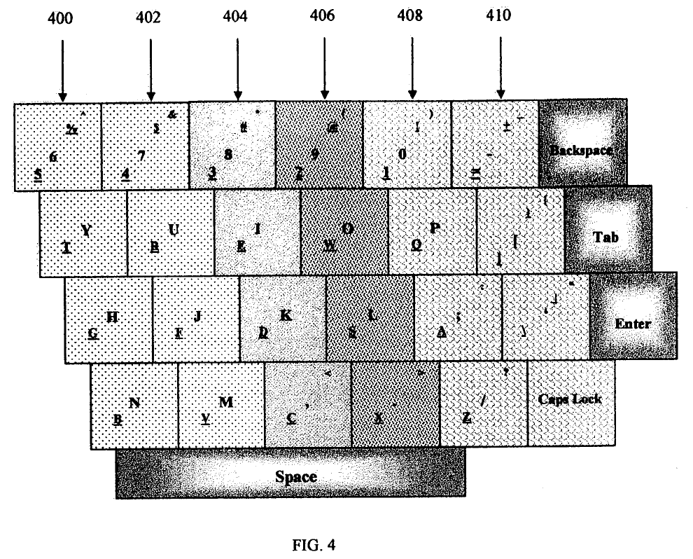

FIG. 4 represents another sensor mapping for the hand-held device. Similar to the FIG. 3 layout, the characters in bold become available when the device is tilted (through sensor 232) in the right hand mode. The underlined characters become available in the left hand mode. The secondary function of each key (denoted at the northeast corner of each cell) can be achieved by tilting the device in the direction of the tilt sensor 234. Analogous to the FIG. 3 layout, when the device is held by the right hand in home position, the index finger is placed on sensors 212 and 214. The letter “u” is typed by pressing 212, and the letter “j” is typed by pressing 214. However, in contrast to the FIG. 3 layout, the letters “y” and “h” are typed by the same sensors 212-214 when sensor 220 is pressed at the same time, or the middle finger or corresponding prosthetic digit is placed upon sensor 228. This is based on the fact that, when a typist uses ten fingers or the corresponding prosthetic digits on a regular QWERTY keyboard, the index and the little fingers or the corresponding prosthetic digits normally control two columns of keys while the middle and ring fingers or the corresponding prosthetic digits control only one column. Therefore, the cells in the leftmost two columns 400-402 can be selected by the index finger. The cells in the third column 404 from the left are selected by the middle finger or corresponding prosthetic digit and the cells in the third column 406 from the right are for use by the ring finger or corresponding prosthetic digit. The rightmost two column 408-410 cells are then used by the little finger or corresponding prosthetic digit. Sensor 222 allows the user to swap between the middle rows of the keyboard to that of the first and fourth. Sensors 224 and 226 are used as a backspace key and a space bar key, respectively. Sensors 216 and 218 are used as enter and tab keys, respectively. Sensor 232 flips between the right-handed and left-handed mode of the device.

The main difference in the two layouts FIG. 3 and FIG. 4 is that the former layout requires less finger or prosthetic digit movement but more sensors (or less characters) than the other. This difference is because, in the FIG. 3 layout the index and little fingers are selecting the keys of only one column.

1. What is claimed is a hand-held reconfigurable keyboard for processing data which consists of an apparatus with at least one device compromising:
A body in a cylinder shape that fits in the palm of a user's hand between the fingers and the bottom of the palm or the equivalent of a gripping prosthetic extension;
A set of sensors, that are placed on the said body;
A sensing subsystem that is placed inside of the said body. The subsystem is operative to transmit a specific signal corresponding to a sensor (or set of sensors) that is (are) pressed (or touched) by the user's digits or fingertips (s) or else are moved by the user's wrist (hand) extension or the prosthetic equivalent of a rotary joint for the hand; and
A receiving subsystem that is connected to the data processing unit. The subsystem is operative to receive a specific signal and send it to the processing unit.

2. The hand-held keyboard of claim 1, where is said the body contains:
Four pairs of sensors on one side; the sensors are positioned such a way that each pair is placed under one of the user's index, middle, ring, or little fingers or the prosthetic equivalent(s) of the digit(s);
Two pairs of sensors and a single sensor on top; the two pair of sensors are positioned in such a way that they can be controlled by the user's thumb or prosthetic opposing digit. The single sensor is able to detect, between the two pairs of sensors, which is covered by the thumb or opposing digit;
A pair of sensors and a single sensor on the side; the pair of sensors is controlled by the thumb or opposing digit. The single sensor is controlled by the index finger or the prosthetic equivalent of a pointing finger; and
A pair of sensors; these sensors are able to detect the user's wrist (hand) or prosthetic rotary joint movement and orientation.

3. An apparatus for inputting data into an information processing system, wherein: the apparatus has at least one device that can be held in the user's palm or prosthetic gripping surface; wherein the device includes a sensing subsystem; the subsystem is operative to recognize the stimuli sensed at different sensors caused by a user's finger or prosthetic digit pressure or the user's wrist (hand) or prosthetic rotary joint movement.

4. An apparatus for inputting data into an information processing system, wherein: the apparatus has two devices in such a way that one can be held in the user's right palm or prosthetic gripping surface, and the other can be held in the user's left palm or prosthetic gripping surface. Each device includes a sensing subsystem; the subsystem is operative to recognize the stimuli sensed at different sensors caused by a user's finger or prosthetic digit pressure or the user's wrist (hand) or prosthetic rotary joint movement.

5. The hand-held device of claim 1, 3, or 4, wherein the transformation of signals from sensing subsystem to receiving subsystem (or information processing system) is done via wireless or optical technology, e.g., via radio frequency (RF) or infrared (IR).

6. The hand-held device of claim 1, 3, or 4, wherein the device compromise: a set of letter keys, and a set of specialized keys.

7. The hand-held device of claim 6, wherein the set of letter keys compromise a QWERTY keyboard.

8. The hand-held device of claim 6, wherein the set of specialized keys include at least a backspace key, an enter key, and a space bar key entry mapping.

9. The hand-held device of claim 1, 3, or 4, wherein the device can be incorporated in a mobile information processing system, a cellular telephone, or a personal digital assistant/organizer.

10. The hand-held device of claim 1, 3, or 4, wherein the device can be incorporated in a game system by mapping the functions of desire keys to the sensors of the said body.
